(19) United States
(12) Patent Application Publication
(10) Pub. No.: US 2025/0337519 A1
(43) Pub. Date: Oct. 30, 2025

(54) APPARATUS AND METHODS FOR PADDING RELATING TO VARIOUS PADDING REQUIREMENTS

(71) Applicant: NXP USA, Inc., AUSTIN, TX (US)

(72) Inventors: Liwen Chu, San Ramon, CA (US); Kiseon Ryu, San Diego, CA (US); Huizhao Wang, San Jose, CA (US); Hongyuan Zhang, Fremont, CA (US); Ken Kinwah Ho, San Jose, CA (US)

(21) Appl. No.: 19/189,123

(22) Filed: Apr. 24, 2025

Related U.S. Application Data
(60) Provisional application No. 63/638,831, filed on Apr. 25, 2024.
(60) Provisional application No. 63/659,281, filed on Jun. 12, 2024.
(60) Provisional application No. 63/659,777, filed on Jun. 13, 2024.
(60) Provisional application No. 63/663,335, filed on Jun. 24, 2024.
(60) Provisional application No. 63/668,537, filed on Jul. 8, 2024.
(60) Provisional application No. 63/686,505, filed on Aug. 23, 2024.

(51) Int. Cl. H04L 1/00; H04L 5/00; H04W 12/106; H04W 28/02

(52) U.S. Cl. CPC H04L 1/0007; H04L 5/0053; H04W 12/106; H04W 28/0278

(57) ABSTRACT

Methods and apparatus for providing padding in relation to various padding requirements. In an example method, a wireless device receives padding requirement information from a second wireless device, the padding requirement information relating to one or more of a padding requirement for Control frame protection or MAC header protection, a padding requirement for switching from a low capability (LC) mode to a high capability (HC) mode, a padding requirement for switching from a primary channel to a secondary channel or Dynamic Sub-Channel Optimization (DSO) channel, or a padding requirement for switching from an Enhanced Multi-Link Single Radio (eMLSR) listening mode to a frame exchange mode. The wireless device generates a physical layer (PHY) protocol data unit (PPDU) including one or more padding fields in accordance with the padding requirement information received from the second wireless device. The wireless device further transmits the PPDU including the one or more padding fields for reception by the second wireless.

### CROSS REFERENCE TO RELATED APPLICATIONS

The present U.S. Utility Patent Application claims priority pursuant to 35 U.S.C. § 119(e) to U.S. Provisional Application No. 63/638,831, entitled “PADDING CONSIDERATION FOR MAC HEADER PROTECTION”, filed Apr. 25, 2024, U.S. Provisional Application No. 63/659,281, entitled “PADDING CONSIDERATION FOR RESPONDING FRAME”, filed Jun. 12, 2024, U.S. Provisional Application No. 63/659,777, entitled “PADDING CONSIDERATION FOR MAC HEADER PROTECTION AND CONTROL FRAME PROTECTION”, filed Jun. 13, 2024, U.S. Provisional Application No. 63/663,335, entitled “ICF PADDING CONSIDERATION”, filed Jun. 24, 2024, U.S. Provisional Application No. 63/668,537, entitled “TRIGGER FRAME DESIGN-PADDING, AID12”, filed Jul. 8, 2024, and U.S. Provisional Application No. 63/686,505, entitled “PROTECTED CONTROL FRAME PADDING”, filed Aug. 23, 2024, the contents of all of which are hereby incorporated herein by reference in their entirety and made part of the present U.S. Utility Patent Application for all purposes.

### BACKGROUND

### Technical Field

This disclosure relates generally wireless communications, and more specifically to padding for frames used in wireless communications.

### Description of Related Art

Wireless local area networks (WLANs) have evolved rapidly over the past couple of decades, including WLANs that conform to the Institute of Electrical and Electronics Engineers (IEEE) 802.11 family of standards. A typical 802.11-based WLAN is formed by one or more access points (APs) that provide a shared wireless communication medium for servicing a number of client devices or stations (STAs). In particular, an AP manages a Basic Service Set (BSS) that is identified by a Basic Service Set Identifier (BSSID) and advertised by the AP. The AP periodically broadcasts beacon frames to enable STAs within wireless range of the AP to establish and maintain communication links with the AP.

In IEEE 802.11 compliant communications, padding bits are utilized for various purposes. For example, in wireless communications it is often necessary for frames to align with specific byte boundaries (e.g., 4-byte, 8-byte, 16-byte boundaries). Padding bits can be added to frames to ensure proper alignment for processing. Padding bits may also be used in data blocks that must be of a fixed size, such as when meeting a size requirement of block cipher encryption algorithm. In other cases, padding bits are added to adjust frame length in order to avoid fragmentation issues, or to fill unused bits in a frame.

### BRIEF DESCRIPTION OF THE DRAWINGS

One or more embodiments will now be described by way of example only with reference to the accompanying drawings, in which:

FIG. 1 illustrates an example of a multi-link communications system in accordance with embodiments of the present disclosure;

FIG. 2 illustrates an example of a Multi-STA Block Ack frame format that may be used to communicate padding requirement information in accordance with embodiments of the present disclosure;

FIG. 3 depicts an example of a Per AID Traffic Identifier (TID) Information subframe including padding requirement information in accordance with an embodiment of the present disclosure;

FIG. 4 illustrates an example of a Quality of Service (Qos) frame or M anagement frame including a protected Media Access Control (MAC) header and padding in accordance with embodiments of the present disclosure;

FIG. 5 illustrates an example of a portion of an Aggregated MAC Protocol Data Unit (A-MPDU) including a QoS frame or Management frame and MPDU delimiters operating as padding in accordance with embodiments of the present disclosure;

FIG. 6 illustrates an example of an A-MPDU having at least one subframe including a protected frame (e.g., a Trigger frame) and padding in accordance with embodiments of the present disclosure;

FIG. 7 illustrates another example of an A-MPDU having subframes including a protected MAC headers and padding in accordance with embodiments of the present disclosure;

FIG. 8 illustrates an example of a format of an MPDU delimiter that can be utilized as padding in accordance with an embodiment of the present disclosure;

FIG. 9 is a logic diagram illustrating an example process for generating padding in a PPDU in accordance with an embodiment of the present disclosure;

FIG. 10 is a logic diagram illustrating another example process for generating a PPDU including a Control frame, a first padding field, and a second padding field in accordance with an embodiment of the present disclosure; and

FIG. 11 illustrates an example of a wireless network device according to an embodiment of the present disclosure.

### DETAILED DESCRIPTION

The various implementations described in the following detailed description relate generally to padding techniques to support and enable various features associated with the IEEE 802.11bn amendment (also referred to as Ultra High Reliability or “UHR” or “Wi-Fi 8”) and future generations of the IEEE 802.11 standard that require padding, such as Control frame protection, effective MAC header protection, Dynamic Sub-Channel Optimization (DSO), and Dynamic Power Save (DPS) mode. In some aspects, a wireless device receives padding requirement information from another wireless device, and applies this information when generating a physical layer (PHY) protocol data unit (PPDU) including a frame having the protected MAC header and one or more padding fields. In further aspects, the PPDU carries an Aggregated MAC Protocol Data Unit (A-MPDU) including one or more frames having a protected MAC header and appropriate padding. The padding requirement information may relate to, for example, a processing time required to decode the protected MAC header, a processing time required to prepare a responsive protected Control frame, and/or processing of a solicited operation such as a channel switch for DSO, DPS operation, Enhanced Multi-Link Single Radio (eMLSR) operation, etc. In an example, a wireless device that transmits a frame in a PPDU to a peer device may trigger the peer the device to use multiple features that require padding. In this example, the wireless device includes padding in the frame and/or PPDU to independently satisfy each of the multiple padding requirements. In another example, if the wireless device transmits multiple frames in a PPDU, padding that is included to satisfy the padding requirements of one frame is not utilized to satisfy the padding requirements of another frame.

As used herein, the term “non-legacy” may refer to PPDU formats and communication protocols conforming with the IEEE 802.11bn amendment to the IEEE 802.11 standard (also referred to as “802.11bn”, “UHR” or “Wi-Fi 8”) as well as future generations/amendments. In contrast, the term “legacy” may be used herein to refer to PPDU formats and communication protocols conforming to the IEEE 802.11be (also referred to as Extremely High Throughput or “EHT” or “Wi-Fi 7”) or IEEE 802.11ax (also referred to as High Efficiency or “HE” or “Wi-Fi 6/6E”) amendments to the IEEE 802.11 standard, or earlier generations of the IEEE 802.11 standard, but not conforming to all mandatory features of 802.11bn or future generations of the IEEE 802.11 standard. In some implementations, the padding mechanisms described herein may support multiple versions of the IEEE 802.11 standard.

Particular implementations of the subject matter described in the present disclosure can be implemented to realize one or more of the following potential advantages. By providing effective padding for implementing Control frame protection, MAC header protection of frames, DPS, DSO, etc., the methodologies described herein improve the power efficiency, medium usage efficiency, and security of wireless communications involving frames such as Control frames (e.g., Trigger frames, BAR frames, Multi-STA Block Ack frames, etc.) and the MAC header of Data and Management frames. Among other examples, such methodologies reduce the risk of packet eavesdropping and spoofing, and ensure that a wireless device receiving a protected frame has sufficient time to check the integrity protection of the received protected Control frame or a fully protected MAC header of the received frame and, in some embodiments, prepare a responsive protected frame (e.g., an A-MPDU or MPDU, BAR, BSR, or BQR frame), and/or perform an operation solicited by a protected frame.

In an example method according to the present disclosure, a wireless device receives padding requirement information from a second wireless device, the padding requirement information relating to Control frame protection, a frame having a protected MAC header, a DPS operation, and/or a DSO operation. The wireless device generates a physical layer (PHY) protocol data unit (PPDU) including the frame having the protected Control frame, having the protected MAC header, having a relation to a DPS operation (e.g., a second device's channel switch from a narrow bandwidth to an operating bandwidth and/or an Nss change) and/or relating to a DSO (e.g., a second device's channel switch from a primary channel to a DSO subband. The PPDU further includes one or more padding fields in accordance with the padding requirement information received from the second wireless device. For example, the one or more padding fields for a frame can relate to preparing a MIC value (or protected MAC header) for a responsive protected frame having an integrity protection requirement, verifying the MIC (or protected MAC header) for a received protected frame with an integrity protection requirement, or processing of a DSO and/or DPS operation solicited by the PPDU. The padding for integrity protection can be applied to the padding for encryption/decryption. The wireless device further transmits the PPDU including the one or more padding fields of a frame for reception by the second wireless device to independently satisfy, when applied, the multiple padding requirements (or a single padding requirement) of the second frame. If a wireless device transmits multiple frames in a PPDU, the included padding field(s) that satisfy one frame's padding requirement(s) are not used to satisfy the padding requirement(s) of another frame.

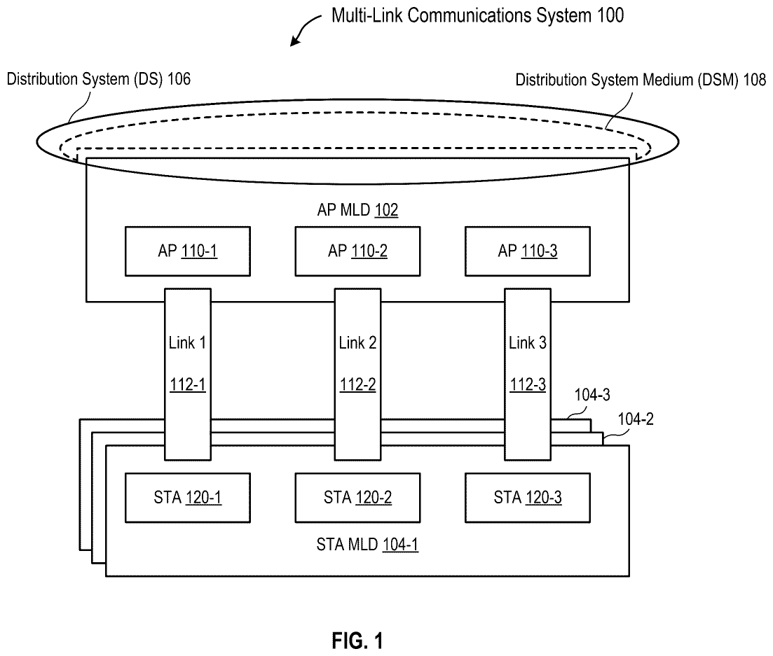

FIG. 1 illustrates an example of a multi-link (ML) communications system 100 in accordance with embodiments of the present disclosure. The illustrated multi-link communications system 100 includes at least one A P multi-link device (MLD) 102, and one or more non-AP multi-link devices, which are, for example, implemented as station (STA) MLDs 104-1, 104-2, 104-3. The multi-link communications system 100 can be used in various applications, such as industrial applications, medical applications, computer applications, and/or consumer or appliance applications. In the illustrated example, the multi-link communications system is a wireless communications system compatible with an IEEE 802.11 standard. Although the depicted multi-link communications system 100 is shown in FIG. 1 with certain components and described with certain functionality herein, other embodiments of the multi-link communications system 100 may include fewer or more components to implement the same, less, or more functionality. For example, although the multi-link communications system 100 is shown in FIG. 1 includes the AP MLD 102 and the STA MLDs 104-1, 104-2, 104-3, in other embodiments, the multi-link communications system includes other multi-link devices, such as multiple AP MLDs and multiple STA MLDs, multiple AP MLDs and a single STA MLD, or a single AP MLD and a single STA MLD. In another example, the multi-link communications system includes more than three STA MLDs and/or less than three STA MLDs. Although the multi-link communications system 100 is shown in FIG. 1 as being connected in a certain topology, the network topology of the multi-link communications system 100 is not limited to the topology shown in FIG. 1.

In the embodiment depicted in FIG. 1, the AP MLD 102 includes multiple radios, implemented as APs 110-1, 110-2, 110-3. In some embodiments, the AP MLD 102 is an AP multi-link logical device or an AP multi-link logical entity (MLLE). In some embodiments, a common part of the AP MLD 102 implements upper layer Media Access Control (MAC) functionalities (e.g., beaconing, association establishment, reordering of frames, etc.) and a link specific part of the AP MLD 102, i.e., the APs 110-1, 110-2, 110-3, implement lower layer MAC functionalities (e.g., backoff, frame transmission, frame reception, security, etc.). The APs 110-1, 110-2, 110-3 may be implemented in hardware (e.g., circuits), software, firmware, or a combination thereof. At least one of the APs 110-1, 110-2, 110-3 may be fully or partially implemented as an integrated circuit (IC) device. In some embodiments, the AP MLD and its affiliated APs 110-1, 110-2, 110-3 are compatible with at least one WLAN communications standard (e.g., at least one IEEE 802.11 standard). For example, the APs 110-1, 110-2, 110-3 may be wireless APs compatible with at least one IEEE 802.11 standard.

In some embodiments, an AP MLD (e.g., the AP MLD 102) is connected to a local network (e.g., a local area network (LAN)) and/or to a backbone network (e.g., the Internet) through a wired connection and wirelessly connects to wireless STA MLDs through one or more WLAN communications standards, such as an IEEE 802.11 standard. In some embodiments, an AP (e.g., the AP 110-1, the AP 110-2, and/or the AP 110-3) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. The at least one controller may be implemented within a processor, such as a microcontroller, a host processor, a host, a digital signal processor (DSP), or a central processing unit (CPU), which can be integrated in a corresponding transceiver. In an example, each of the APs 110-1, 110-2, 110-3 of the AP MLD 104 operates in different frequency bands. For example, at least one of the APs 110-1, 110-2, 110-3 of the AP MLD 104 operates in a 2.4/5/6/45/60 Gigahertz (GHz) frequency band. For example, the AP 110-1 may operate at a 6 Gigahertz (GHz) band (e.g., in a 320 MHz Basic Service Set (BSS) operating channel or other suitable BSS operating channel), the AP 110-2 may operate at 5 GHz band (e.g., a 160 MHz BSS operating channel or other suitable BSS operating channel), and the AP 110-3 may operate at 2.4 GHz band (e.g., a 20 MHz BSS operating channel or other suitable BSS operating channel) or a 60 GHz band (e.g., with a 160 MHz BSS operating channel or other suitable BSS operating channel).

In the illustrated embodiment, the AP MLD is connected to a distribution system (DS) 106 through a distribution system medium (DSM) 108. The distribution system (DS) 106 may be a wired network or a wireless network that is connected to a backbone network such as the Internet. The DSM 108 may be a wired medium (e.g., Ethernet cables, telephone network cables, or fiber optic cables) or a wireless medium (e.g., infrared, broadcast radio, cellular radio, or microwaves). Although the AP MLD 102 is shown in FIG. 1 as including three APs, other embodiments of the AP MLD 102 may include fewer than three APs or more than three APs. In addition, although some examples of the DSM 108 are described, the DSM 108 is not limited to the examples described herein.

In the embodiment depicted in FIG. 1, the STA MLD 104-1 includes radios, which are implemented as multiple non-AP stations (STA s) 120-1, 120-2, 120-3. The STAs 120-1, 120-2, 120-3 may be implemented in hardware (e.g., circuits), software, firmware, or a combination thereof. At least one of the STAs 120-1, 120-2, 120-3 may be fully or partially implemented as an IC device. In some embodiments, the non-AP STAs 120-1, 120-2, 120-3 are part of the STA MLD 104-1, such that the STA MLD may be a communications device that wirelessly connects to an AP MLD, such as, the AP MLD 102. For example, the STA MLD 104-1 (e.g., at least one of the non-AP STA s 120-1, 120-2, 120-3) may be implemented in a laptop, a desktop personal computer (PC), a mobile phone, or other communications device that supports at least one WLAN communications standard. In some embodiments, the STA MLD and its affiliated STAs 120-1, 120-2, 120-3 are compatible with at least one IEEE 802.11 standard. In an example, each of the non-AP STAs 120-1, 120-2, 120-3 includes at least one antenna, at least one transceiver operably connected to the at least one antenna, and at least one controller connected to the corresponding transceiver. The at least one transceiver may include a PHY device. The at least one controller can be configured to control the at least one transceiver to process received packets through the at least one antenna. In some embodiments, the at least one controller is implemented by a processor, such as a microcontroller, a host processor, a host, a DSP, or a CPU, which can be integrated in a corresponding transceiver. In an example, the STA MLD has one MAC data service interface. In another example, a single address is associated with the MAC data service interface and is used to communicate on the DSM 108. In some embodiments, the STA MLD 104-1 implements a common MAC data service interface and the non-AP STAs 120-1, 120-2, 120-3 implement a lower layer MAC data service interface.

In an example, the AP MLD 102 and/or the STA MLDs 104-1, 104-2, 104-3 identify which communications links support the multi-link operation during a multi-link operation setup phase and/or exchanges information regarding multi-link capabilities during the multi-link operation setup phase. Each of the STAs 120-1, 120-2, 120-3 of the STA MLD may operate in a different frequency band. For example, at least one of the STA s 120-1, 120-2, 120-3 of the STA MLD 104-1 operates in the 2.4/5/6 GHz frequency band. For example, the STA 120-1 may operate at 6 GHz band (e.g., in a 320 MHz BSS operating channel or other suitable BSS operating channel), the STA 120-2 may operate at 5 GHz band (e.g., a 160 MHz BSS operating channel or other suitable BSS operating channel), and the STA 120-3 may operate at 2.4 GHz band (e.g., a 20 MHz BSS operating channel or other suitable BSS operating channel) or a 60 GHz band (e.g., with a 160 MHz BSS operating channel or other suitable BSS operating channel. Although the STA MLD 104-1 is shown in FIG. 1 as including three non-AP STAs, other embodiments of the STA MLD 104-1 may include fewer than three non-AP STAs or more than three non-AP STA s.

Each of the MLDs 104-2, 104-3 may be the same as or similar to the MLD 104-1. For example, the MLD 104-2 or 104-3 includes one or multiple non-AP STAs. In some embodiments, each of the non-AP STAs includes at least one antenna, at least one transceiver operably connected to the at least one antenna, and at least one controller connected to the corresponding transceiver. In some embodiments, the at least one transceiver includes a PHY device. The at least one controller can be configured to control the at least one transceiver to process received packets through the at least one antenna. In some embodiments, the at least one controller is implemented by a processor, such as a microcontroller, a host processor, a host, a DSP, or a CPU, which can be integrated in a corresponding transceiver.

In the illustrated network, the STA MLD 104-1 communicates with the AP MLD 102 through multiple communications links 112-1, 112-2, 112-3. For example, each of the STAs 120-1, 120-2, 120-3 communicates with an AP 110-1, 110-2, or 110-3 through a corresponding wireless communications link 112-1, 112-2, or 112-3. Although the AP MLD 102 communicates (e.g., wirelessly communicates) with the STA MLD 104-1 through multiple links 112-1, 112-2, 112-3, in other embodiments, the AP MLD 102 may communicate (e.g., wirelessly communicate) with the STA MLD through more than three communications links or less three than communications links. In some embodiments, the communications links in the multi-link communications system are wireless communications links, which may include one or more 2.4/5/6/45/60 GHz links.

In various embodiments, either a non-AP STA or an AP may announce separate padding requirements for performing various actions. Such actions may include, for example, a Dynamic Power Save (DPS) bandwidth and/or Nss change, a Dynamic Sub-Channel Optimization (DSO) channel switch, configuring and/or checking a protected Control frame, and preparing and/or checking a protected MAC header of a unicast Data/M anagement frame. The padding requirements may depend, in part, on the processing capabilities of the non-AP STA/AP and whether various processing tasks are performed by the same logic (e.g., preparing the MIC of a protected Control frame and checking the integrity of a protected Control frame, preparing the MIC of a protected MAC header and/or the protected MAC header) or differing logic (e.g., security integrity protection and channel switching). In an example, a STA/AP may announce a single security padding requirement for generating the message integrity check (MIC) value of a responding Control frame, checking the MIC value of a received Control frame, generating the MIC value of a protected MAC header, or checking the MIC value of a received Control frame and generating the MIC value of a responding Control frame.

In another example, a STA/AP may announce a padding requirement for checking the MIC value of a received Control Frame (e.g., a BSRP Trigger frame or a Multi-STA Block Ack (Multi-STA BA or M-BA)) and an additional requirement for preparing the MIC value of a protected responsive Control frame. In this example, if the same logic is required to perform both MIC-related operations, the padding of the protected Control Frame (either the initial Control frame or control responding frame) should be of sufficient length to satisfy the sum of the first padding requirement and the second padding requirement. In a specific example, a STA/AP may announce a first padding requirement for checking the message integrity check (MIC) value of a received Control Frame (e.g., a BSRP Trigger frame, a Basic Trigger frame, a MU BAR or M-BA) and a second padding requirement for preparing the MIC value of a protected responsive Control frame (e.g., a Multi-STA Block Ack frame). In this example, if the same logic is required to perform both MIC-related operations, the padding of the Control Frame (e.g., BSRP Trigger frame, MU BAR) that solicits the protected Control frame should be of sufficient length to satisfy the sum of the first padding requirement and the second padding requirement. If the same logic is required to perform both MIC-related and the protected Control frame does not solicit a responsive protected Control frame, the padding of the protected Control frame should be of sufficient length to satisfy the first padding requirement. In the foregoing example, the first padding requirement and the second padding requirement may have same value, and a padding requirement announced for one requirement may be applied to other requirement. In other examples described more fully below, a transmitted PPDU may include multiple protected frames in an A-MPDU, and the padding requirements of a receiving device can be addressed in various ways depending, e.g., on whether the A-MPDU further includes non-protected frames that can be treated as all or part of a padding field for a protected frame. In other examples described more fully below, a transmitted PPDU may include padding required for a recipient to perform a channel switch or mode switch from a low capability (LC) mode to a high capability (HC) mode.

Generally, each of the padding requirements must be met independently. This means that if a frame is subject to multiple padding requirements (e.g., padding 1 and padding 2), the padding of the frame must satisfy each requirement separately. However, in certain embodiments, a padding field(s) may concurrently satisfy all or part of more than one padding requirement. The padding requirements can relate to padding that serves various functions, such as the following:

### 1. Control Frame Protection

Padding to ensure a recipient has sufficient time to prepare a responding Control frame (e.g., the padding in an A-MPDU or MPDU that solicits a protected Control frame, the padding in a BAR, BSRP, BQRP frame that solicits a protected Multi-STA Block Ack, etc.).
Padding to ensure a recipient has sufficient time to decode received protected Control frames (e.g., Trigger frames, BAR frames, Multi-STA Block Ack frames, etc.).

### 2. Soliciting Control Frames

Padding to allow a recipient time to switch modes, such as:
switching from a low capability (LC) mode to a high capability (HC) mode when recipient is in a Dynamic Power Save (DPS) mode;
switching from a primary channel to a secondary channel or Dynamic Sub-Channel Optimization (DSO) channel; or
switching from an Enhanced Multi-Link Single Radio (eMLSR) listening mode to a frame exchange mode.

### 3. MAC Header Protection

Padding to allow a recipient time to decode protected MAC headers in unicast QoS Data frames and M anagement frames.

As used herein, the term “length” refers generally to a period of time (e.g., corresponding to a processing requirement of a recipient device) corresponding to the time being used to transmit the padding fields or the other fields being used as padding (e.g., the size of one or more padding fields divided by the data rate (or MCS+Nss) being used to transmit the padding). In an example, the length of a padding field(s) as restricted by padding requirement information corresponds to a processing time requirement of a wireless device. Further, a period of time represented by padding requirement information can be indicated in fixed or granular units of time. In some examples, the padding portions of a frame for meeting differing padding requirements may start at different locations in the frame. For example, the padding in a BSRP Trigger frame that allows an addressed STA to prepare a responding TB PPDU may start after the User Info field addressed to the STA, while padding that relates to integrity checking of the BSRP Trigger frame may start after the MIC field of the BSRP Trigger frame.

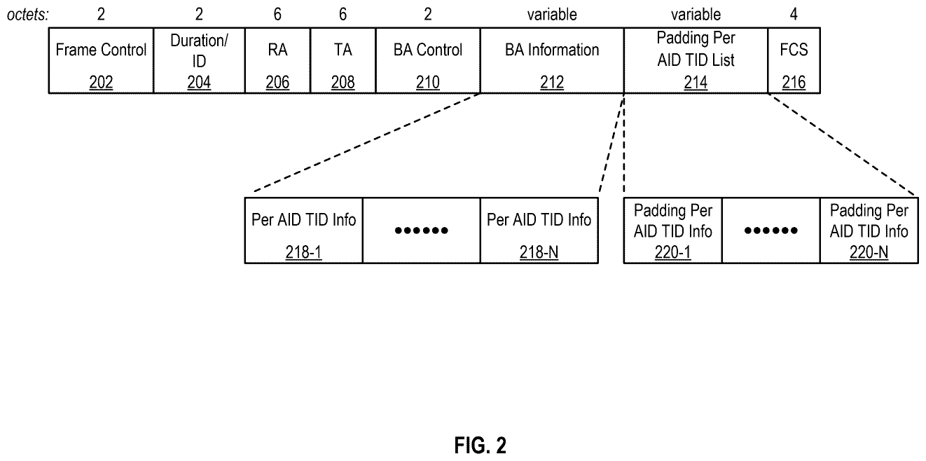

FIG. 2 illustrates an example format of an updated Multi-STA Block Ack frame 200 that may be used to carry padding in one or more Per AID Info fields (“Padding Per AID Info fields”) in accordance with embodiments of the present disclosure. The Multi-STA BlockAck frame 200 of the illustrated example includes a plurality fields, including a Frame Control field 202, a Duration/ID field 204, an RA field 206, a TA field 208, a BA Control field 210, a BA Information field 212, a Padding Per AID TID List 214 and an FCS field 216 (e.g., a 32-bit field containing a 32-bit CRC value that is calculated over certain fields of the MAC header and the frame body fields).

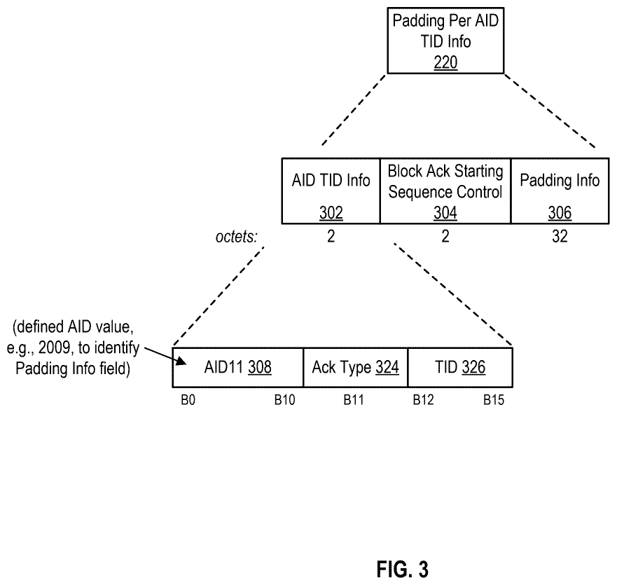

The BA Information field 212 of this example includes a Per AID TID Info fields 218 that may be defined with a special AID value to indicate a dynamic resource request/response (e.g., suggested Tx parameters, a requested TXOP duration, etc.). For example, a Block Ack Bitmap field of a legacy Multi-STA BlockAck frame is redefined as a Control Information field for a dynamic resource request. In an example, a TXOP responder may request that a TXOP holder adjust its Tx parameters (e.g., PPDU length, BW, Nss, MCS, etc.). In this example, the TXOP holder may not be able to utilize the suggested Tx parameters within an SIFS time period after receiving the suggested Tx parameters. In this instance, the TXOP holder can announce corresponding padding requirement information in a responding Control frame. The padding part (e.g., at least a portion of the required padding) may need to satisfy, for example, a first padding requirement for decoding a protected Control frame and a second padding requirement for decoding suggested Tx parameters and/or a suggested TXOP duration. As described in conjunction with FIG. 3, such padding requirements can be fulfilled in one or more Padding Per AID TID Info fields 220 of the Padding Per AID TID List 214.

FIG. 3 depicts an example of a Padding Per AID Traffic Identifier (TID) Info field 220 including padding bits. In the illustrated example, the Padding Per AID TID Info field 220 includes an AID TID Info field 302, a Block Ack Starting Sequence control field 304, and a Padding Info field 306 that carries padding. In various embodiments, the number of the Padding Info fields 306 can be carried in the Multi-STA BA to satisfy the padding requirement using a granularity option announced when enabling the related feature(s) in a related management frame (e.g., as indicated by one or more granularity bits to select a defined unit of time). In examples, valid padding values or units for Control frame protection include ¼ μs (or the same as the MPDU minimum start spacing), ½ μs, 1 μs, 2 μs, 4 μs, 8 μs, 16 μs, 32 μs, 64 μs, 128 μs, etc. In another example, valid padding values are announced with a linear granularity of ¼ μs, minimum value of 0 μs, and maximal value of 4 μs. In yet another example, valid padding values are announced with a granularity of ⅛ μs or 1/16 μs, minimum value of 0 μs, and maximal value of 16 μs. Further, different granularity options (e.g., 4 μs, 8 μs, 16 μs) may be used to express padding values relating to solicited operations such as mode or channel switching.

In the illustrated example, the AID TID Info field 302 includes an AID 11 subfield 308 (e.g., 11 bits), an Ack Type subfield 324 (e.g., 1 bit), and a traffic identifier (TID) subfield 326. The AID 11 subfield 308 can be set to a defined value that indicates the presence of padding information/padding. In an example, the AID 11 subfield 308 is set to defined value greater than 2007 (e.g., 2009) to identify the Padding Info field 306. In addition, the Ack Type subfield 324 may be set to 0 to carry the non-zero Padding Info field 306.

In other non-limiting examples, a Trigger frame (a type of Control frame) carried in a non-HT duplicated PPDU may include a portion of required padding in its padding field, and a Block Acknowledgement Request (BAR) frame (another type of Control frame) carried in a non-HT duplicated PPDU may include padding information in a padding field that immediately precedes the FCS field. As described more fully herein, when a protected frame is carried in a PPDU other than a non-HT duplicated PPDU, MPDU delimiters that follow the frame can be utilized as padding fields to meet a padding requirement of a recipient device.

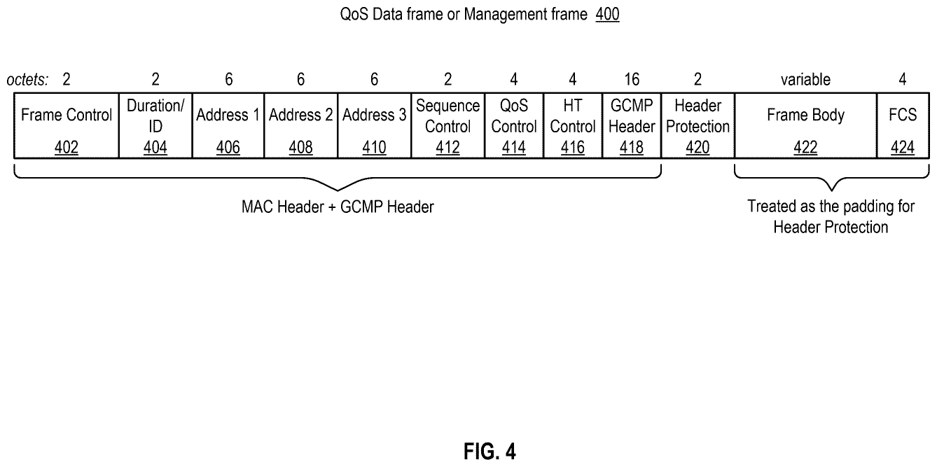

FIG. 4 illustrates an example of a Quality of Service (QOS) data frame or Management frame 400 including a protected Media Access Control (MAC) header and padding in accordance with embodiments of the present disclosure. The QoS/M anagement frame 400 of the illustrated example includes a plurality of fields, including a Frame Control field 402, a Duration/ID field 404, an Address 1 field 406 (e.g., a receiver address), an Address 2 field 408 (e.g., a transmitter address), an Address 3 field 410 (e.g., a destination address), a Sequence Control field 412, a QoS Control field 414, an HT Control field 416 (or HE variant HT Control field), a GCM P Header field 418, a Header Protection field 420, a frame body 422 including payload data, and an FCS field 418. In the illustrated example, fields 402-418 comprise a protected MAC header. In some implementations, the GCM P (Galois Counter Mode Protocol) header 418 includes fields for initialization vectors, counters, and other cryptographic parameters used for encryption and authentication, and the Header Protection field 420 (e.g., 16 bits) includes a combination of packet number (PN) information, key identification information to identify a pairwise transient key for MAC header protection, and message integrity check (MIC) information.

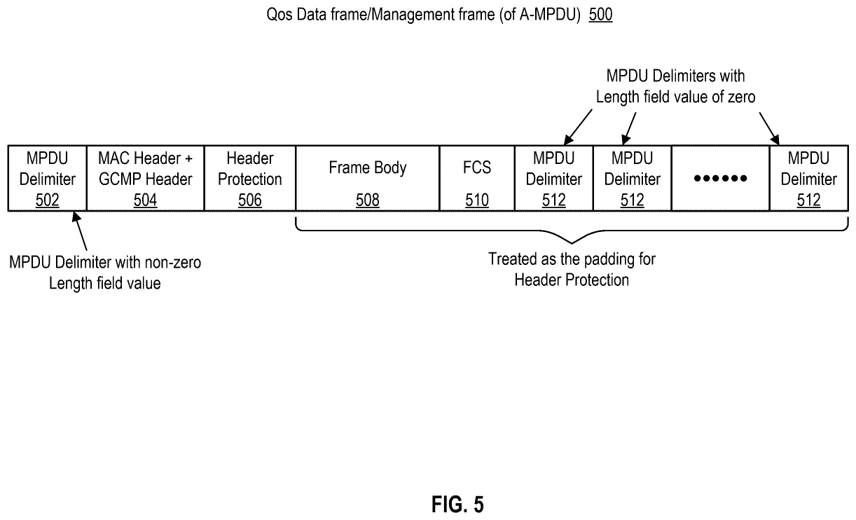

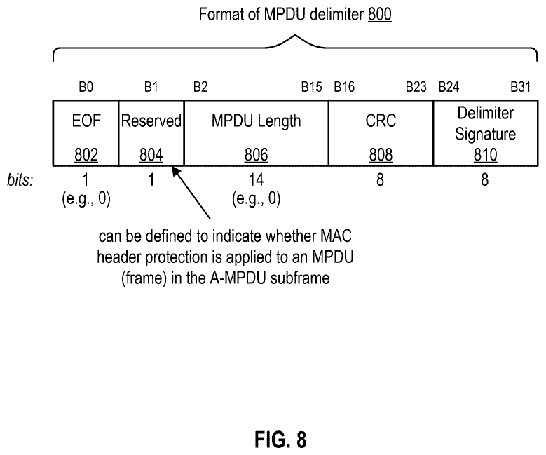

In an example, the frame body 422 and the FCS field 424 that follow the Header Protection field 420 are treated as the padding (or part of the padding) for header protection. In another example in which the (unicast) QoS Data frame or Management frame 400 is carried in a non-HT PPDU, and the padding for MAC header protection can include, for example, one or more MPDU delimiters that follow the frame as described with reference to FIG. 5. An example of an MPDU delimiter used for padding is described with reference to FIG. 8.

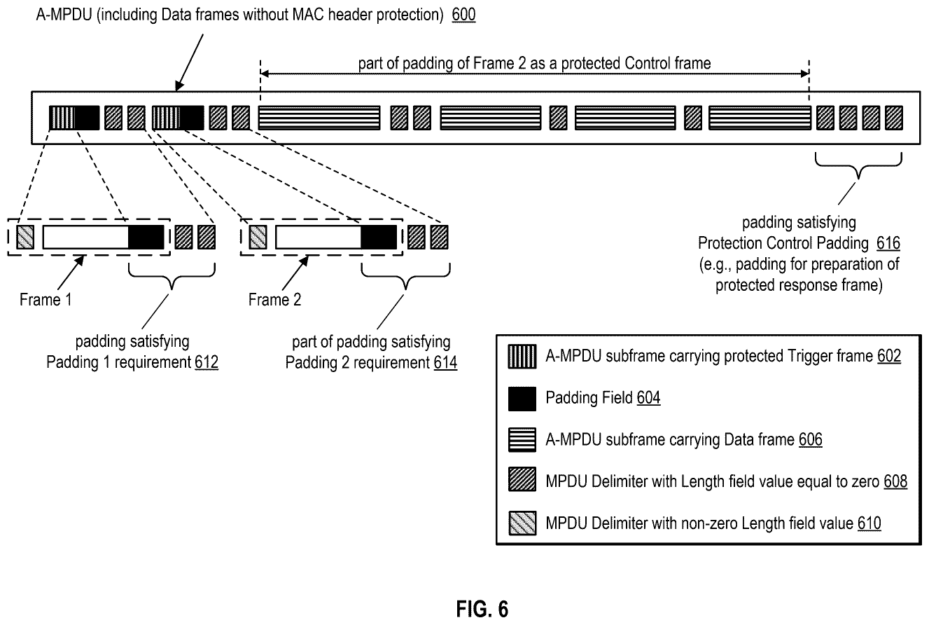

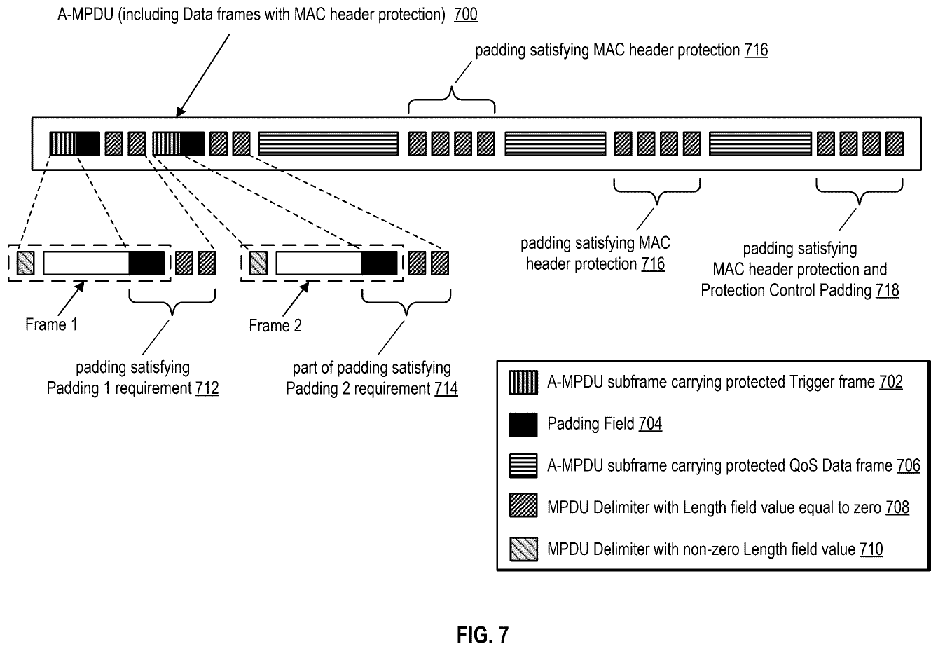

FIG. 5 illustrates an example of a portion of an Aggregated MAC Protocol Data Unit (A-MPDU) including a Qos Data frame or Management frame 500 and MPDU delimiters functioning as padding in accordance with embodiments of the present disclosure. In the illustrated example, the QoS Data frame/M anagement frame 500 fields follow an MPDU delimiter 502 having a non-zero Length field value indicating the length of the frame. The Qos Data frame/M anagement frame 500 includes MAC Header and GCM P header fields 504, a Header Protection field 506, a frame body 508, and an FCS field 510. In this example, one or more MPDU delimiters 512 having a Length field value of zero follow the FCS field 510, and are included in the A-MPDU as a padding part. Specifically, a sufficient number of MPDU delimiters 512 are provided to satisfy (in combination with the frame body 508 and FCS field 510) a padding requirement(s) indicated by a recipient wireless device. For example, after the last A-MPDU subframe or the only A-MPDU subframe that carries the unicast Data/Management frame with MAC header protection in a PPDU other than non-HT PPDU, the MPDU Delimiters with an End of Field value equal to zero and a Length field value equal to zero are carried in the PPDU. Examples of an A-M PDU that includes multiple protected frames are described below with reference to FIGS. 6 and 7. In one example, only the MPDU Delimiters with the Length field value of zero that follow the FCS field 510 are the padding part of the QoS Data frame or Management frame 500 with the protected MAC header. In another example, the fields of a frame with MAC header protection after the Header Protection field 506 and the MPDU Delimiters with the Length field value of zero follow the FCS field 510 are the padding part of the Data/Management frame with the protected MAC header.

FIG. 6 illustrates an example of an A-MPDU 600 having at least one subframe including a protected frame (e.g., a basic Trigger frame) and padding in accordance with embodiments of the present disclosure. The A-MPDU 600 is constructed to use various types of padding (i.e., padding fields) to satisfy the padding requirements of a recipient wireless device(s). In an example, the padding included to satisfy the padding requirement(s) of one aggregated frame are not used to satisfy the padding requirement(s) a another aggregated frame, and each padding requirement is independently satisfied by the padding.

In the illustrated example, the A-MPDU 600 includes n protected Control frames (e.g., sequentially aggregated Frame 1, Frame 2, . . . Frame n) having respective padding requirements of Padding 1, Padding 2, . . . Padding n, where Padding j (0<j<=n). The protected Control frames of this example include the following security padding requirements:

The padding for protected Control Frame n satisfies the padding requirement (Padding n) of Control frame protection where the following can be part of the padding:
the padding field in Frame n (zero or more bits);
an A-MPDU Delimiter(s) with a Length field value equal to zero and an End of Field value equal to zero after Frame n and preceding any subsequent A-MPDU subframe(s) carrying a frame with MAC header protection; and/or
an A-MPDU subframe(s) carrying a frame without MAC header protection and before any following A-MPDU subframe(s) carrying a frame with MAC header protection or padding included for preparation of a protected responding Control frame.

The padding for protected Control Frame j (0<<<n) satisfies the padding requirement (Padding j) of Control frame protection where the following can be part of the padding:
the padding field in Frame j (zero or more bits)
an A-MPDU Delimiter(s) with a Length field value equal to zero (and an End of Field value equal to zero) after Frame j and preceding any subsequent A-MPDU subframe(s) carrying a frame with MAC header protection.

In the illustrated example, the A-MPDU 600 includes multiple protected basic Trigger frames 602 (e.g., to solicit BA/ACKs in TB PPDUs) in respective A-MPDU subframes, and one or more subframes carrying a Data frame 606 without MAC header protection. A first protected Trigger frame is included in Frame 1, which further includes an MPDU Delimiter with a non-zero Length field value (610) and a padding field 604. The A-MPDU 600 of this example includes one or more MPDU Delimiters with a Length field value equal to zero 608 which, in combination with the padding field 604, provides padding (612) satisfying padding requirement 1 of the first protected Trigger frame (e.g., padding that relates to decryption of the MAC header of the Trigger frame). Likewise, a second protected Trigger frame is included in Frame 2, which further includes an MPDU Delimiter with a non-zero Length field value (610) and a padding field 604. The A-MPDU 600 of this example includes one or more MPDU Delimiters with a Length field value equal to zero 608 following Frame 2 which, in combination with the Padding Field 604 and one or more subframes carrying a Data frame 606 without MAC header protection, provides padding (614) satisfying padding requirement 2 of the second protected Trigger frame. In an example, each of the protected basic Trigger frames requires the padding as it may not be clear which Trigger frame will be decoded.

As illustrated in FIG. 6, the A-MPDU 600 further includes one or more MPDU Delimiters with a Length field value equal to zero 608 following the last subframe of the A-MPDU. These additional MPDU Delimiters can provide padding (616) to satisfy a Protection Control padding requirement for the recipient to prepare a protected Control frame only. In an example, the padding for satisfying the Protection Control padding requirement relates to a time requirement of a recipient wireless device for preparing a protected responding Control frame.

In another example, the A-MPDU 600 can include a single protected BSRP Trigger frame or MU-RTS Trigger frame used as an Initial Control Frame to trigger a UHR non-AP STA to switch to another link, another subchannel, and/or extend to a larger bandwidth such as eMLSR/eMLMR, Non-Primary Channel Access, Power Save, Dynamic Subband Operation, etc. For example, the MU-RTS Trigger frame can be used as the Initial Control Frame between an AP affiliated with an AP MLD and a non-AP STA affiliated with a non-AP MLD that is in the EM LSR mode.

FIG. 7 illustrates another example of an A-MPDU 700 having subframes including protected Control frames, protected MAC headers and padding in accordance with embodiments of the present disclosure. The A-MPDU 700 is constructed to use various types of padding (i.e., padding fields) to satisfy the padding requirements of a recipient wireless device(s). In an example, the padding included to satisfy the padding requirement(s) of one aggregated frame are not used to satisfy the padding requirement(s) a another aggregated frame and, if multiple padding requirements are being applied to a frame, each of the padding requirements is independently satisfied by the padding.

In the illustrated example, the A-MPDU 700 includes one or more protected basic Trigger frames 702 in respective A-MPDU subframes, and one or more subframes carrying a QoS Data frame 706 with MAC header protection. Each of the protected Trigger frames 702 may require padding related to Control frame protection padding. Each of the frames 706 may require padding relating to its respective protected MAC header. A first protected Trigger frame is included in Frame 1, which further includes an MPDU Delimiter with a non-zero Length field value (710) and a padding field 704. The A-MPDU 700 of this example includes one or more MPDU Delimiters with a Length field value equal to zero 708 which, in combination with the padding field 704, provides padding (712) satisfying padding requirement 1 of the first protected Trigger frame (e.g., padding that relates to decryption of the MAC header of the Trigger frame). In this example, the padding 712 for the first protected Control/Trigger frame is only utilized to satisfy a padding requirement of the first protected Control/Trigger frame (i.e., not used to meet a padding requirement of a successive protected Control frame). Likewise, a second protected Trigger frame is included in Frame 2, which further includes an MPDU Delimiter with a non-zero Length field value (710) and a padding field 704. The A-MPDU 700 of this example includes one or more MPDU Delimiters with a Length field value equal to zero 708 following Frame 2 which, in combination with the Padding Field 704 provides padding (714) satisfying padding requirement 2 of the second protected Trigger frame and is only utilized to satisfy a padding requirement (e.g., relating to the protection of a Control frame) of the second protected Trigger frame.

In this example, the A-MPDU 700 further includes a plurality of subframes carrying QoS Data frames 706 having protected MAC headers. A first QoS Data frame 706 is followed by one or more MPDU Delimiters with a Length field value equal to zero 708 that provide cumulative padding (716) to satisfy a padding requirement for MAC header protection of the first QoS Data frame 706 (and is not utilized, for example, to meet a padding requirement related to protection checking of another frame). A second QoS Data frame 706 is similarly followed by padding 716, etc.

As illustrated in FIG. 7, the A -MPDU 700 further includes one or more MPDU Delimiters with a Length field value equal to zero 708 following the last subframe of the A-MPDU. In one embodiment, these additional MPDU Delimiters can provide padding (718) (e.g., 24 μs) to satisfy a padding requirement for (only) the last QoS Data frame's MAC header protection padding (e.g., 8 μs for a recipient to check the integrity of the MIC field of the protected MAC header of the last frame) and a Protection Control padding requirement. In an example, the Protection Control padding requirement relates to a time requirement of a recipient wireless device for preparing a protected responding Control frame.

A protected Control frame of a first type may be aggregated with other types of protected Control frames and/or unprotected frames in an Aggregated MAC Protocol Data Unit (A-MPDU). In an example, a protected Trigger frame(s) and a QoS Data frame are aggregated in a DL-MPDU. In another example, multiple protected Trigger frames having the same content are aggregated in an A-MPDU. In yet another example, one or more protected Trigger frames are aggregated with a Multi-STA BA frame and one or more Qos Data frames in a DL A-MPDU. In a further example, a Multi-STA BA frame and one or more Qos Data frames are aggregated in a DL/UL A-MPDU. In these examples, the A-M PDU includes padding to meet the padding requirement information of the last protected Control frame of each type of protected Control frame in the A-MPDU.

The present disclosure is not limited to the foregoing examples, and the protected Control frames and padding techniques for an A-MPDU may be arranged with differing orderings, differing numbers of subframes, differing padding field lengths, etc.

In such scenarios, a PPDU carrying protected Control frames with multiple padding requirements may need to satisfy the security padding requirement of the each protected Control frame of the A-MPDU. In an example, an Initial Control Frame (ICF) in a transmit opportunity (TXOP) can include an explicit indication of whether the Initial Control Frame is the last frame addressed to a recipient device in the TXOP. In another example, the recipient device may determine that the Control frame is the last frame based on the Duration/ID subfield of the Initial Control Frame.

In an example, the following padding requirements are separately announced (e.g., through a Management frame(s)):
the padding requirement for an addressed STA's TB PPDU transmission (Padding-1), announced by the STA as the recipient of various Trigger frames;
the padding requirement for a STA/AP to check a MIC value of a protected Control frame (Padding-2.1) announced by the STA/AP as the recipient of the protected Control frame;
the padding requirement for a STA/AP to prepare a protected Control frame (e.g., protected multi-STA BA) (padding 2.2) after receiving the soliciting Control frame or the A-MPDU;
the padding requirement for a STA or AP to process the initial control information of an ICF for a DSO channel switch (Padding-3.1), for a DPS mode switch (Padding-3.2), and/or for a link switch for EM LSR operation (Padding-3.3) announced by the STA/AP.

In an example, each of the padding requirements required by a frame is independently satisfied. Referring more specifically to various padding fields in a protected Trigger frame, various types of padding can be accommodated:
the padding for an addressed STA's TB PPDU Tx (Padding-1) (e.g., beginning at the end of the User Info addressed to the STA);
the padding for an addressed STA to check the MIC value (Padding-2.1) (e.g., beginning after MIC);
the padding for an addressed STA to process an ICF (Padding-3.1) for switching from a primary channel to a secondary channel or Dynamic Sub-Channel Optimization (DSO) channel, the padding for an addressed STA to process an ICF (Padding-3.2) for switching from a low capability mode to a high capability mode, the padding for an addressed STA to process an ICF (Padding-3.3) for switching from an Enhanced Multi-Link Single Radio (eMLSR) listening mode to a frame exchange mode, etc., beginning after a MIC field and pre-padding FCS.

In another example, the following padding requirements are separately announced (e.g., via a Management frame(s)):
the padding requirement for an addressed STA's TB PPDU transmission (Padding-1), announced by the STA as the recipient of various Trigger frame(s);
the padding requirement for a STA/AP to check a MIC value of a received protected Control frame and/or prepare the protected responding Control frame (protected multi-STA BA) (Padding-2.1) announced by the STA/AP;
the padding requirement for a STA/AP to prepare a protected Control frame (protected multi-STA BA) (Padding 2.2) after receiving a soliciting Control frame or A-MPDU;
the padding requirement for a STA or AP to process the initial control information of an ICF for DSO channel switch (Padding-3.1), for DPS mode switch (Padding-3.2), and/or for link switch for eMLSR operation (Padding 3.3) announced by the STA/AP.

In an example, each of the padding requirement is satisfied independently.

The foregoing padding configurations are provided by way of example and without limitation.

In an example, if a TXOP responder enables at least one of a DSO channel switch, DPS capability mode switch and Control frame protection, the TXOP holder may include padding for the TXOP responder in a protected ICF such that the padding after the intermediate FCS field satisfies the maximal value of protected Control frame padding, DSO channel switch padding (if supported), DPS capability mode switch padding (if supported), and Control frame protection padding (e.g., independently satisfies the DSO padding requirement and the DPS capability mode switch padding requirement). In addition, the padding after the User Info field addressed to a TXOP responder should satisfy the padding requirement for preparing a responsive TB PPDU.

In another example, if a TXOP responder enables a DSO channel switch, a DPS capability mode switch, and Control frame protection, the TXOP holder may include padding for the TXOP responder in a protected ICF soliciting the TXOP responder's DSO operation and DPS operation such that the padding satisfies the sum of the protected Control frame padding, DSO channel switch padding (if supported), and capability mode switch padding (if supported).

FIG. 8 illustrates an example of a format of an MPDU delimiter 800 that can be utilized as padding in accordance with an embodiment of the present disclosure. An MPDU typically serves as a boundary marker for individual MPDUs within an A-MPDU, allowing a receiving device to identify where one MPDU ends and the next begins in the aggregated frame. As described herein, the MPDU delimiter 800 can modified/repurposed to operate as padding in a padding field that satisfies, in whole or part, a padding requirement of recipient wireless device.

The MPDU delimiter 800 depicted in FIG. 8 is one example of the MPDU delimiter 512 of FIG. 5, the MPDU delimiter 608 of FIG. 6, and the MPDU delimiter 708 of FIG. 7. In the illustrated example, the MPDU delimiter 800 includes an end of frame (EoF) subfield 802 (e.g., one-bit) that may be set to 0 when an MPDU delimiter is being used for padding. The MPDU delimiter 800 further includes a reserved subfield 804 (e.g., 1 bit), an MPDU length subfield 806 (e.g., 14 bits) that contains MPDU length information, a cyclic redundancy check (CRC) subfield 808 (e.g., 8-bits) that contains CRC information for the preceding 16 bits, and a delimiter signature subfield 810 (e.g., 8-bits) that contains a unique pattern that may be used to detect an MPDU delimiter. In an example, the MPDU length subfield 806 can be set to 0 when an M PD U delimiter is being used to meet a padding requirement. In a further example, the reserved subfield 804 can be defined to indicate whether MAC header protection is applied to an MPDU (frame) in an A-MPDU subframe.

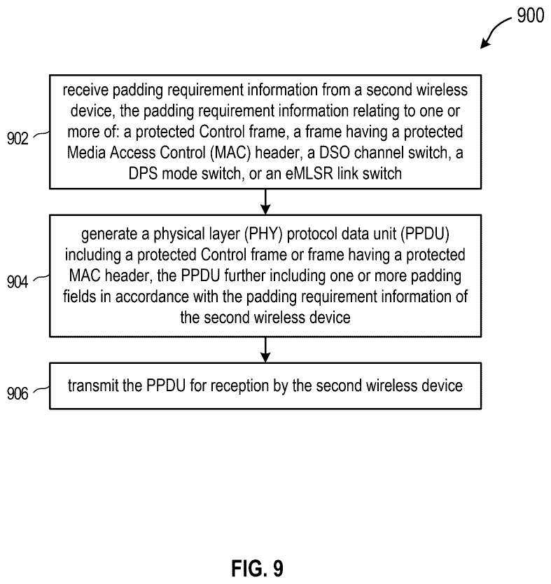

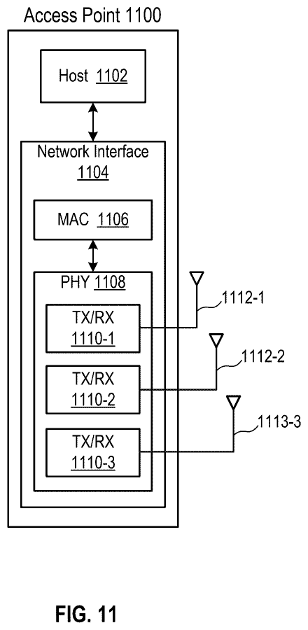

FIG. 9 is a logic diagram illustrating an example process 900 for generating padding in a PPDU. The process 900 can be performed by an access point (AP), such as the AP MLD 102 described with reference to FIG. 1 or the AP 1100 described with reference to FIG. 11. In another example, the process 900 can be similarly performed by a UHR STA (e.g., when generating a protected frame for reception by a UHR AP). The process 900 may be utilized, for example, to generate PPDUs such as described with reference to FIGS. 4-8.

The method begins at step 902 where the AP (first wireless device) receives padding requirement information (e.g., in units of us) from a second wireless device, the padding requirement information relating to processing requirements for a received protected Control frame, a received frame having a protected MAC header, a DSO channel switch, a DPS mode switch, or an eMLSR link switch. In an example, the second wireless device announces a padding requirement(s) for a Trigger frame or other Control frame in relation to a service that the second wireless device supports (e.g., the announcement may be made during a negotiation for service activation or during an association process, via an the request frame for a DSO/DPS enabling request frame, through a MAC capabilities field, etc.). The method continues at step 904 where the AP generates a physical layer (PHY) protocol data unit (PPDU) including the protected Control frame or frame having a protected MAC header. The PPDU further includes one or more padding fields in accordance with the padding requirement information received from the second wireless device. The method then proceeds to step 906 where the AP transmits the PPDU for reception by the second wireless device (e.g., a UHR STA). Among other features, the padding for a DSO channel switch, a DPS mode switch, and the integrity protection of a protected Control frame or frame having a protected MAC header allows additional time for a channel switch, a DPS mode switch, and MIC(s) to be verified at a transmitter/recipient wireless device.

In an example, the one or more padding fields are constructed to accommodate a processing time required by the second wireless device to decrypt and/or encrypt a protected frame or process an operation solicited by the PPDU. Operations solicited by the PPDU can include, for example, switching from a low capability (LC) mode to a high capability (HC) mode, switching from a primary channel to a DSO channel, and switching from an eMLSR listening mode to a frame exchange mode. In various embodiments, the one or more padding fields include one or more MPDU delimiters that operate as padding.

In another example, the frame having a protected MAC header is a unicast Data frame or a unicast Management frame, and the padding requirement information includes a padding requirement for decoding the protected MAC header. In a further example, the padding requirement information includes a plurality of padding requirements, and the cumulative length of the one or more padding fields is equal to or greater than the sum of the padding requirements indicated by the plurality of padding requirements. In a yet another example, the padding requirement information includes a plurality of padding requirements, and the cumulative length of the one or more padding fields is equal to or greater than the maximal value of the plurality of padding requirements.

In another example, the PPDU includes an Aggregated MAC Protocol Data Unit (A-MPDU) having at least one frame including a protected MAC header (or protected Control frame), and the one or more padding fields for the last frame having a protected MAC header includes one or more MPDU delimiters having an End of Field (EoF) subfield set to 0 (zero) and a Length subfield set to 0 (zero). In a further example, the one or more padding fields for the frame including the protected MAC header/protected Control frame includes one or more MPDU delimiters and at least a portion of an unprotected frame of the A-MPDU. If the A-MPDU carries multiple protected Control frames, the A-MPDU can include padding to meet the padding requirement information of each protected Control frame in the A-MPDU.

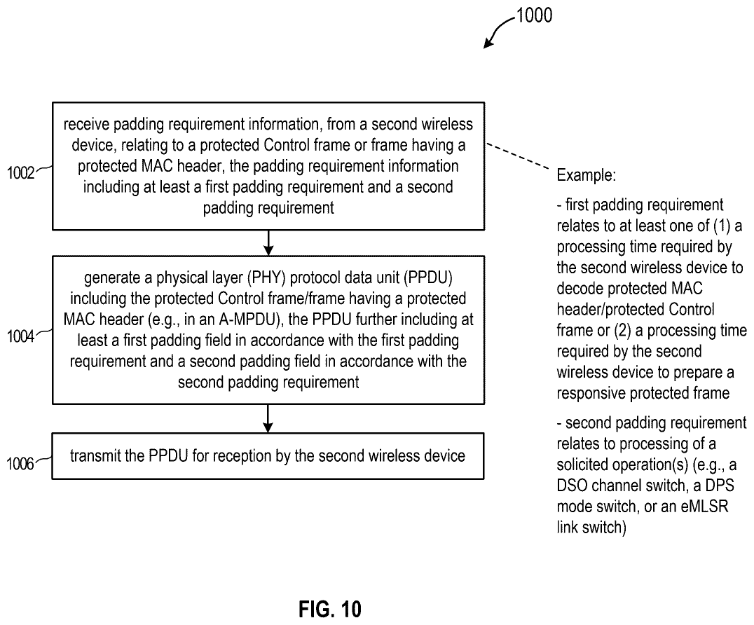

FIG. 10 is a logic diagram illustrating an example process 1000 for generating a PPDU including a Control frame, a first padding field, and a second padding field in accordance with an embodiment of the present disclosure. The process 1000 can be performed by an access point (AP), such as the AP MLD 102 described with reference to FIG. 1 or the AP 1100 described with reference to FIG. 11. In another example, the process 1000 can be similarly performed by a UHR STA (e.g., when generating a protected frame for reception by a UHR AP). The process 1000 may be utilized, for example, to generate PPDUs such as described with reference to FIGS. 4-8.

The method begins at step 1002 where the AP (first wireless device) receives padding requirement information (e.g., in units of us) from a second wireless device, the padding requirement information relating to processing requirements for a received protected Control frame or frame having a protected MAC header. In the illustrated method, the padding requirement information includes at least a first padding requirement and a second padding requirement. For example, the second wireless device can announce a first padding requirement relating to at least one of (1) a processing time required by the second wireless device to decode the protected MAC header (e.g., including a MIC field)/protected Control frame and/or (2) a processing time required by the second wireless device to prepare a responsive protected frame (e.g., including a MIC field), and the second padding requirement relating to processing of an operation solicited by the Control frame. In an example, the second padding requirement(s) relates to processing of a DSO channel switch, a DPS mode switch, or an eMLSR link switch.

The method continues at step 1004 where the AP generates a PPDU including a protected Control frame or frame having a protected MAC header. The PPDU further includes at least a first padding field in accordance with the first padding requirement and a second padding field in accordance with the second padding requirement(s). In an example, the PPDU includes one or more protected Control frames and/or one or more frames having a protected MAC header, and respective padding fields, in an A-MPDU. The method then proceeds to step 1006 where the A P transmits the PPDU for reception by the second wireless device (e.g., a UHR STA).

FIG. 11 illustrates an example of a wireless network device that is configured as an access point (AP) 1100 according to an embodiment of the present disclosure. The AP 1100 is configurable to receive padding requirement information and generate PPDUs including padding and protected frames according to any of the various embodiments described herein. The illustrated AP 1100 includes a host processor 1102 coupled to a network interface device 1104. The network interface device 1104 includes a medium access control (MAC) processing unit 1106 and a physical layer (PHY) processing unit 1108. The PHY processing unit 1108 includes a plurality of transceivers 1110 coupled to a plurality of antennas 1112. Although three transceivers 1110 (1110-1, 1110-2 and 1110-3) and three antennas 1112 (1112-1, 1112-2 and 1112-3) are illustrated in FIG. 1, the AP 1100 includes other suitable numbers (e.g., 1, 2, 4, 5, etc.) of transceivers 1110 and antennas 1112 in other embodiments. In an example, the MAC processing unit 1106 and the PHY processing unit 1108 are configured to operate in compliance with the IEEE 802.11bn amendment to the IEEE 802.11 standard. In an example, the network interface device 1104 includes one or more integrated circuit (IC) devices. In this example, at least some of the functionality of the MAC processing unit 1106 and at least some of the functionality of the PHY processing unit 1108 can be implemented on a single IC device. As another example, at least some of the functionality of the MAC processing unit 1106 is implemented on a first IC device, and at least some of the functionality of the PHY processing unit 1108 is implemented on a second IC device. The AP 1100 may communicate (e.g., trigger-based communications) with a plurality of client stations (not separately illustrated), including both legacy and non-legacy client stations.

In various embodiments, the PHY processing unit 1108 of the AP 1100 is configured to generate data units having formats described herein. The transceiver(s) 1110 is/are configured to transmit the generated data units via the antenna(s) 1112. Similarly, the transceiver(s) 1110 is/are configured to receive data units via the antenna(s) 1112. The PHY processing unit 1108 of the AP 1100 is configured to process received data units conforming to formats described herein.

In an embodiment, when operating in single-user mode, the AP 1100 transmits a (unicast) data unit to a single client station (DL SU transmission), or receives a data unit transmitted by a single client station (UL SU transmission), without simultaneous transmission to, or by, any other client station. When operating in multi-user mode, the A P 1100 transmits a data unit that includes multiple data streams for multiple client stations (DL MU transmission), or receives data units simultaneously transmitted by multiple client stations (UL MU transmission). For example, in multi-user mode, a data unit transmitted by the AP includes multiple data streams simultaneously transmitted by the AP 1100 to respective client stations using respective spatial streams allocated for simultaneous transmission to the respective client stations and/or using respective sets of OFDM tones corresponding to respective frequency sub-channels allocated for simultaneous transmission to the respective client stations. In a further example, the AP 1100 may be configured as a multi-link device, such as the AP MLD 102 described above with reference to FIG. 1.

While the innovative aspects of the present disclosure have been generally described in the context of the 802.11bn amendment, and future generations, of the IEEE 802.11 standard, a person having ordinary skill in the art will readily recognize that teachings herein may be applied to other wireless networks and standards including, for example, Long Term Evolution (LTE) standards and Bluetooth standards.

The innovative methods and apparatus illustrated in the drawings and described herein provide for padding in association with a frame(s) (e.g., a unicast Data/Management frame) having a protected Media Access Control (MAC) header, a protected Control frame, a Control frame soliciting a DPS mode switch, a Control frame soliciting a DSO channel switch, etc. In an illustrative, non-limiting embodiment, a method for wireless communication by a first wireless communication device is provided. The method includes receiving, from a second wireless device, padding requirement information relating to one or more of a padding requirement for Control frame protection or MAC header protection, a padding requirement for switching from a low capability (LC) mode to a high capability (HC) mode, a padding requirement for switching from a primary channel to a secondary channel or Dynamic Sub-Channel Optimization (DSO) channel, or a padding requirement for switching from an Enhanced Multi-Link Single Radio (eMLSR) listening mode to a frame exchange mode. The method further includes generating, by the first wireless device, a physical layer (PHY) protocol data unit (PPDU) including one or more padding fields in accordance with the padding requirement information of the second wireless device. The method further includes transmitting, by the first wireless device, the PPDU for reception by the second wireless device.

The method of this embodiment includes optional aspects. With one optional aspect, the PPDU carries a single frame and the padding requirement information includes a plurality of padding requirements applicable to the single frame, where each of the plurality of padding requirements is independently satisfied by the one or more padding fields. With another optional aspect, the PPDU carries a single frame and the padding requirement information includes a single padding requirement applicable to the single frame, and the single padding requirement is satisfied by the one or more padding fields. In yet another optional aspect, the PPDU carries at least a first frame and a second frame and the padding requirement information includes padding requirements applicable to the first frame and the second frame. In this optional aspect, the one or more padding fields independently satisfy the padding requirements applicable to the first frame and the padding requirements applicable to the second frame.

In another optional aspect, the padding requirement for Control frame protection or MAC header protection includes a padding requirement for generating a protected Control frame, a padding requirement for checking the integrity protection of a received protected Control frame, or a padding requirement for generating a protected Control frame and checking the integrity protection of a received protected Control frame. With another optional aspect, the padding requirement for Control frame protection or MAC header protection further includes a separate padding requirement for checking the integrity protection of a protected MAC header. In still another optional aspect, the padding requirement for Control frame protection or MAC header protection includes separate padding requirements for generating a protected Control frame and checking the integrity protection of a received protected Control frame.

In a further optional aspect, the PPDU includes a protected Control frame that solicits a responsive protected Control frame from the second wireless device, and the one or more padding fields satisfy the sum of the padding requirement for generating a protected Control frame and the padding requirement for checking the integrity protection of a received protected Control frame. In another optional aspect, the protected Control frame is a protected Buffer Status Report Poll (BSRP) Trigger frame or a Block Acknowledgement Request (BAR) frame. In yet another optional aspect, the padding requirement for Control frame protection or MAC header protection further includes a separate padding requirement for checking the integrity protection of a protected MAC header. In a further optional aspect, the padding requirement information for Control frame protection or MAC header protection includes one or more of a padding requirement for generating a protected Control frame, a padding requirement for checking the integrity protection of a received protected Control frame, or a padding requirement for checking a protected MAC header of a received frame.

In another optional aspect of the method, the PPDU includes an Aggregated MAC Protocol Data Unit (A-MPDU) having at least one subframe including MAC header protection, and the one or more padding fields for each subframe having MAC header protection include one or more MPDU delimiters having an End of Field (EoF) subfield set to 0 (zero) and a Length subfield set to 0 (zero). In this optional aspect, the one or more MPDU delimiters precede any successive subframe including MAC header protection. In a further optional aspect, the PPDU includes an Aggregated MAC Protocol Data Unit (A-MPDU) having at least one of subframe including a protected Control frame, and the one or more padding fields for each subframe including a protected Control frame includes one or more MPDU delimiters that precede any successive subframe including a protected Control frame. In yet another optional aspect, the PPDU includes an Aggregated MAC Protocol Data Unit (A-MPDU) carrying multiple frames having a protected MAC header.

With another illustrative, non-limiting embodiment, a method for wireless communication by a wireless communication device is provided. The method includes receiving, from a second wireless device, padding requirement information relating to a protected Control frame. The padding requirement information includes at least a first padding requirement and a second padding requirement. The method further includes generating a physical layer (PHY) protocol data unit (PPDU) including the protected Control frame. The PPDU further includes at least a first padding field in accordance with the first padding requirement and a second padding field in accordance with the second padding requirement. In this embodiment, the first padding requirement relates to at least one of a processing time required by the second wireless device to decode the protected Control frame or a processing time required by the second wireless device to prepare a responsive protected frame, and the second padding requirement relates to processing of an operation solicited by the protected Control frame.

With another illustrative, non-limiting embodiment, a wireless device includes one or more wireless transceivers and one or more processors operably coupled to the one or more wireless transceivers. The one or more processors are configured to receive, via the one or more wireless transceivers, padding requirement information of a second wireless device. The padding requirement information relates to at least one of: a padding requirement for Control frame protection or MAC header protection, a padding requirement for switching from a low capability (LC) mode to a high capability (HC) mode, a padding requirement for switching from a primary channel to a secondary channel or Dynamic Sub-Channel Optimization (DSO) channel, or a padding requirement for switching from an Enhanced Multi-Link Single Radio (eMLSR) listening mode to a frame exchange mode. The one or more processors of the wireless device are further configured to generate a physical layer (PHY) protocol data unit (PPDU) includes one or more padding fields in accordance with the padding requirement information. The one or more processors are further configured to transmit, via the one or more wireless transceivers, the generated PPDU for reception by the second wireless device.

This third embodiment includes optional aspects. With one optional aspect, the PPDU carries a single frame and the padding requirement information includes a plurality of padding requirements applicable to the single frame, where each of the plurality of padding requirements is independently satisfied by the one or more padding fields. In another optional aspect, the PPDU carries at least a first frame and a second frame and the padding requirement information includes padding requirements applicable to the first frame and the second frame, and wherein the one or more padding fields independently satisfy the padding requirements applicable to the first frame and the padding requirements applicable to the second frame.

In still another optional aspect, the PPDU solicits a responsive Multi-STA Block Ack frame. In yet another optional aspect, the one or more padding fields include one or more MPDU delimiters that operate as padding.

To implement various operations described herein, computer program code (i.e., program instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks. The program instructions may also be loaded onto a processing core, processing circuitry, computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

As may be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may further be used herein, the term(s) “arranged to”, “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with” includes direct and/or indirect coupling of separate items and/or one item being embedded within another item.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processor”, “processing circuitry”, “processing circuit”, “processing module”, and/or “processing unit” may be a single processing device or a plurality of processing devices. Such a processing device may be a microprocessor, microcontroller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. Further, such a processing device may include a plurality of processing cores or processing domains, which may operate on separate power domains. The processor, processing circuitry, processing circuit, processing module, and/or processing unit may be (or may further include) memory and/or an integrated memory element, which may be a single memory device, a plurality of memory devices, and/or embedded circuitry of another processor, processing circuitry, processing circuit, processing module, and/or processing unit. Such a memory device may be a read-only memory, random access memory, volatile memory, non-volatile memory, static memory, dynamic memory, flash memory, cache memory, and/or any device that stores digital information. Note that if the processor, processing circuitry, processing circuit, processing module, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processor, processing circuitry, processing circuit, processing module, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processor, processing circuitry, processing circuit, processing module, and/or processing unit executes, hard coded and/or operational instructions corresponding to at least some of the steps and/or functions illustrated in one or more of the figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims.

To the extent used, the logic diagram block boundaries and sequence could have been defined otherwise and still perform the certain significant functionality. Such alternate definitions of both functional building blocks and logic diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors/processing cores executing appropriate software and the like or any combination thereof.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

The term “module” may be used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for wireless communication by a first wireless device, the method comprising:
receiving, from a second wireless device, padding requirement information relating to one or more of:
a padding requirement for Control frame protection or MAC header protection;
a padding requirement for switching from a low capability (LC) mode to a high capability (HC) mode;
a padding requirement for switching from a primary channel to a secondary channel or Dynamic Sub-Channel Optimization (DSO) channel; or
a padding requirement for switching from an Enhanced Multi-Link Single Radio (eMLSR) listening mode to a frame exchange mode;
generating a physical layer (PHY) protocol data unit (PPDU) including one or more padding fields in accordance with the padding requirement information of the second wireless device; and
transmitting the PPDU for reception by the second wireless device.

2. The method of claim 1, wherein the PPDU carries a single frame and the padding requirement information includes a plurality of padding requirements applicable to the single frame, and wherein each of the plurality of padding requirements is independently satisfied by the one or more padding fields.

3. The method of claim 1, wherein the PPDU carries a single frame and the padding requirement information includes a single padding requirement applicable to the single frame, and wherein the single padding requirement is satisfied by the one or more padding fields.

4. The method of claim 1, wherein the PPDU carries at least a first frame and a second frame and the padding requirement information includes padding requirements applicable to the first frame and the second frame, and wherein the one or more padding fields independently satisfy the padding requirements applicable to the first frame and the padding requirements applicable to the second frame.

5. The method of claim 1, wherein the padding requirement for Control frame protection or MAC header protection includes:
a padding requirement for generating a protected Control frame;
a padding requirement for checking the integrity protection of a received protected Control frame; or
a padding requirement for generating a protected Control frame and checking the integrity protection of a received protected Control frame.

6. The method of claim 5, wherein the padding requirement for Control frame protection or MAC header protection further includes a separate padding requirement for checking the integrity protection of a protected MAC header.

7. The method of claim 1, wherein the padding requirement for Control frame protection or MAC header protection includes separate padding requirements for generating a protected Control frame and checking the integrity protection of a received protected Control frame.

8. The method of claim 7, wherein the PPDU includes a protected Control frame that solicits a responsive protected Control frame from the second wireless device, and wherein the one or more padding fields satisfy the sum of the padding requirement for generating a protected Control frame and the padding requirement for checking the integrity protection of a received protected Control frame.

9. The method of claim 8, wherein the protected Control frame is a protected Buffer Status Report Poll (BSRP) Trigger frame or a Block Acknowledgement Request (BAR) frame.

10. The method of claim 7, wherein the padding requirement for Control frame protection or MAC header protection further includes a separate padding requirement for checking the integrity protection of a protected MAC header.

11. The method of claim 1, wherein the padding requirement information for Control frame protection or MAC header protection includes one or more of:
a padding requirement for generating a protected Control frame;
a padding requirement for checking the integrity protection of a received protected Control frame; or
a padding requirement for checking a protected MAC header of a received frame.

12. The method of claim 1, wherein the PPDU includes an Aggregated MAC Protocol Data Unit (A-MPDU) having at least one subframe including MAC header protection, and wherein the one or more padding fields for each subframe having MAC header protection include one or more MPDU delimiters having an End of Field (EoF) subfield set to 0 (zero) and a Length subfield set to 0 (zero), wherein the one or more MPDU delimiters precede any successive subframe including MAC header protection.

13. The method of claim 1, wherein the PPDU includes an Aggregated MAC Protocol Data Unit (A-MPDU) having at least one of subframe including a protected Control frame, and wherein the one or more padding fields for each subframe including a protected Control frame includes one or more MPDU delimiters, wherein the one or more MPDU delimiters precede any successive subframe including a protected Control frame.

14. The method of claim 1, wherein the PPDU includes an Aggregated MAC Protocol Data Unit (A-MPDU) carrying multiple frames having a protected MAC header.

15. A method for wireless communication by a first wireless device, the method comprising:
receiving, from a second wireless device, padding requirement information relating to a protected Control frame, the padding requirement information including at least a first padding requirement and a second padding requirement; and
generating a physical layer (PHY) protocol data unit (PPDU) including the protected Control frame, the PPDU further including at least a first padding field in accordance with the first padding requirement and a second padding field in accordance with the second padding requirement,
wherein the first padding requirement relates to at least one of a processing time required by the second wireless device to decode the protected Control frame or a processing time required by the second wireless device to prepare a responsive protected frame, and
wherein the second padding requirement relates to processing of an operation solicited by the protected Control frame.

16. A wireless device, comprising:
one or more wireless transceivers; and
one or more processors operably coupled to the one or more wireless transceivers, wherein the one or more processors are arranged to:
receive, via the one or more wireless transceivers, padding requirement information of a second wireless device, the padding requirement information relating to at least one of:
a padding requirement for Control frame protection or MAC header protection;
a padding requirement for switching from a low capability (LC) mode to a high capability (HC) mode;
a padding requirement for switching from a primary channel to a secondary channel or Dynamic Sub-Channel Optimization (DSO) channel; or a padding requirement for switching from an Enhanced Multi-Link Single Radio (eM LSR) listening mode to a frame exchange mode;
generate a physical layer (PHY) protocol data unit (PPDU) including one or more padding fields in accordance with the padding requirement information; and
transmit, via the one or more wireless transceivers, the PPDU for reception by the second wireless device.

17. The wireless device of claim 16, wherein the PPDU carries a single frame and the padding requirement information includes a plurality of padding requirements applicable to the single frame, and wherein each of the plurality of padding requirements is independently satisfied by the one or more padding fields.

18. The wireless device of claim 16, wherein the PPDU carries at least a first frame and a second frame and the padding requirement information includes padding requirements applicable to the first frame and the second frame, and wherein the one or more padding fields independently satisfy the padding requirements applicable to the first frame and the padding requirements applicable to the second frame.

19. The wireless device of claim 16, wherein the PPDU solicits a responsive Multi-STA Block Ack frame.

20. The wireless device of claim 16, wherein the one or more padding fields include one or more MPDU delimiters that operate as padding.
